(19) United States
(12) Patent Application Publication
(10) Pub. No.: US 2010/0174575 A1
(43) Pub. Date: Jul. 8, 2010

(54) MEETING MANAGEMENT SYSTEM WITH FAILOVER AND FAILBACK CAPABILITIES FOR MEETING MODERATORS

(75) Inventors: COLM FARRELL, CLONSILLA (IE); LIAM HARPUR, SKERRIES (IE); PATRICK J. O'SULLIVAN, BALLSBRIDGE (IE); CAROL S. ZIMMET, BOXBOROUGH, MA (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/348,074

(22) Filed: Jan. 2, 2009

(51) Int. Cl. G06Q 10/00

(52) U.S. Cl. 705/8; 705/7

(57) ABSTRACT

Meeting management software can include a moderator assigner module. The moderator assigner can include a moderator failover capability and a moderator failback capability. The moderator failover capability can substitute a replacement for a moderator when the moderator is determined to be unavailable for a scheduled meeting. The moderator failback capability can substitute a moderator for a replacement when a believed to be unavailable moderator is determined to be available for a scheduled meeting for which the replacement has been established.

### BACKGROUND

The present invention relates to the field of meeting management systems and, more particularly, to a meeting management system with failover and failback meeting moderator capabilities.

Meeting management systems (sometimes referred to as a calendaring systems or scheduling system) are computerized systems that facilitate meetings. These systems permit meetings to be scheduled at a particular time and place and communicate specifics of meetings to participants. Some meeting management systems permit one participant to be designated as a meeting moderator. The moderator can direct discussions during the meeting. The moderator may also have to coordinate pre or post meeting activities, such as disseminating documents to be shared at a meeting and performing follow-up actions.

Often, a designated moderator is unable to attend a meeting. This generally requires some other individual be appointed as a moderator. Currently, this process is an ad-hoc and manual one. That is, a human, such as a moderator's manager or the moderator himself/herself, designates a stand-in or a replacement. This designation can be time consuming and imprecise, due to varying availability of stand-in personnel for a required time, to a skill-set of a desired moderator needed to be matched to a specific event, and to other factors. Also, a need to determine a replacement can occur on very short notice, such as when a moderator is unable to attend a scheduled meeting due to an emergency.

Once a replacement has been assigned/determined, suitable permissions to meeting documents, which are often secured on computing devices and require passwords, must be established for the replacement. Then, meeting attendees may have to be notified and/or meeting specific communications (e.g., email) may have to be directed towards the replacement moderator. This entire situation may have to be reversed, should the originally assigned moderator become available before the meeting occurs.

### BRIEF DESCRIPTION OF THE SEVERAL VIEWS OF THE DRAWINGS

FIG. 1 is a schematic diagram of a system implementing meeting management software having failover and failback capabilities for meeting moderators in accordance with an embodiment of the inventive arrangements disclosed herein.

FIG. 2 shows a configure moderator interface in accordance with an embodiment of the inventive arrangements disclosed herein.

FIG. 3 is a flow chart of a method implementing failover and failback functionality for meeting moderators in accordance with an embodiment of the inventive arrangements disclosed herein.

### DETAILED DESCRIPTION

The disclosure provides a failover and a failback capability for a meeting management system where replacement moderators are appointed when a meeting moderator is unavailable. Should an originally scheduled moderator become available before a meeting occurs, a failback function can swap a replacement with the originally scheduled moderator. A replacement moderator can be automatically determined by the meeting management system based upon numerous factors, such as seniority, skill level, expertise, location, availability, department, familiarity with meeting content, relationship with other participants, and the like. Additionally, the meeting management system can automatically and preemptively determine a likelihood that a moderator is going to miss a meeting based upon an analysis of electronic communications and other data sources. Analysis can include activity monitoring as well as an analysis of data content. In one implementation, a determination that an appointed moderator is going to miss a meeting can cause a replacement moderator to be automatically appointed.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer usable program code embodied in the medium.

Any combination of one or more computer usable or computer readable medium(s) may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer usable or computer readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

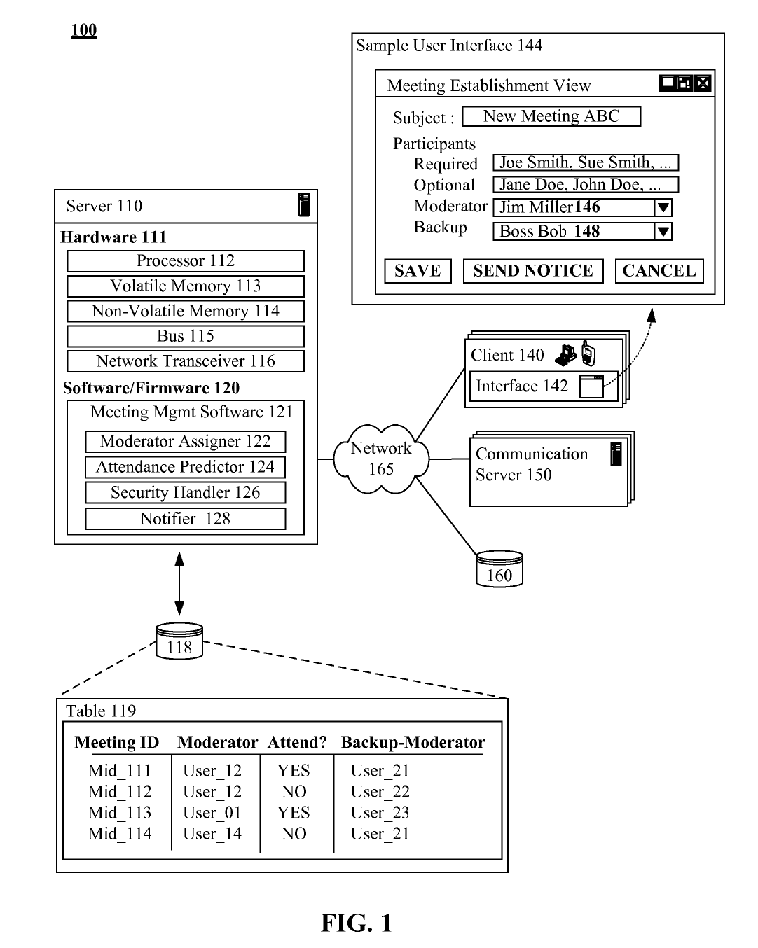

FIG. 1 is a schematic diagram of system 100 implementing meeting management software 121 having failover and failback capabilities for meeting moderators in accordance with an embodiment of the inventive arrangements disclosed herein. In system 100, a server 110 running meeting management software 121 can be communicatively linked to a set of clients 140, a set of communication servers 150, and other data sources 160 via network 165. The server 110 can include hardware 110 of a processor 112, volatile memory 113, non-volatile memory 114 and network transceiver 116 connected by bus 115. The hardware 110 can execute software/firmware 120, which can be stored in a storage medium, such as the non-volatile memory 114.

Meeting participants, including a moderator, backup moderator, and other participants, can use user interfaces 142 of clients 140 to interact with the meeting management software 120. Sample user interface 144, for example, shows how a moderator 146 and backup moderator 148 can be designated when a meeting is established. Meeting management software 121 can manage records relating to meetings. For instance, table 119 of a server 110 accessible data store 118 can include records that associate moderators, a moderator attendant status, backup moderators, and the like with unique meeting keys.

Interface(s) 142 can also present user calendars that show established meetings that the users are scheduled to attend. These interfaces 142 can also show who a current meeting moderator is, even when the moderator has changed based upon failover or failback actions taken by meeting management software 121. Interfaces 142 of a moderator and/or replacement can also permit either to accept or refute meeting related changes. Notices of meeting changes, which include moderator changes, can also be initiated and received using the user interfaces 142.

A moderator assigner 122 module of software/firmware 121 can be used to update meeting specific records related to moderators. The assigner 122 can also programmatically determine or recommend a moderator for a meeting. This assigner 122 determined moderator can be a backup or replacement moderator as well as an initial moderator for a meeting. Moderators can be chosen based upon a number of factors, which can be optionally configured. Various ones of these factors can be weighed more than others depending upon implementation specifics. The rules and factors used by the assigner 122 can include general or default rules/factors as well as situation dependent factors. For example, different meeting types can be associated with different factors or factor weights. Further, a set of default factors and/or rules can be overridden for a specific meeting. In one embodiment, moderators themselves (or meeting owners) can establish moderator-specific factors within the assigner 122 to bias selection procedures in accordance with individual preferences.

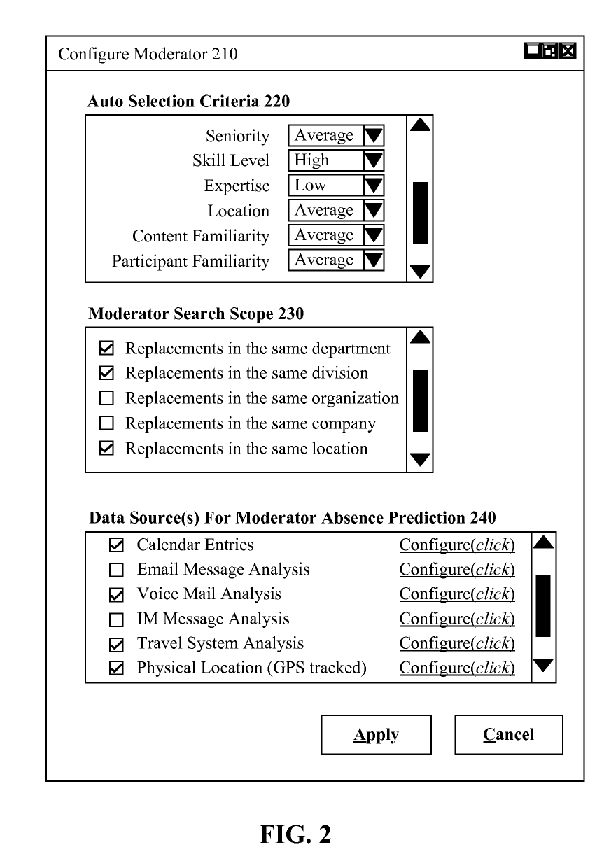

A selection criteria 220 section of a configure moderator 210 interface shown in FIG. 2 illustrates some sample criteria, which the moderator assigner 122 can utilize. Criteria 220 can include, for example, seniority, skill level expertise, location, content familiarity, participant familiarity, and other factors. Each factor can be weighed, such as given a high, average, low priority. The priorities can translate into a numeric weigh, which is applied when an overall selection score for a potential moderator is calculated. Additional criteria 220, such as those defined by affiliations within a social networking context, can be used in other embodiments of the disclosure.

In one embodiment, a scope of potential moderators can be configured and/or defined. Section 230 of interface 210 shows some scope limiting criteria for moderator candidates. For example, replacement moderators can be restricted to those sharing a department, division, organization, company, location, project, and the like as an original moderator. Other candidate criteria can also be established, as desired.

To illustrate, when the moderator assigner 122 module suggests and/or determines a moderator for a meeting, it can first determine a set of candidate moderators from which to choose. A personnel, contact management, or other database of individuals can be filtered based upon scope limiting parameters (e.g., those of section 230). Assigner 122 can generate a moderator suitability score (using factors and weights such as those shown in criteria 220) for each candidate moderator. A moderator candidate with a highest score can be made a tentative moderator, who may or may not have to accept a nomination for being moderator depending upon implementation specifics. If a moderator candidate refuses to be moderator, a person with a next highest suitability score can be made a tentative moderator, and so forth.

In one contemplated implementation, white lists and/or black lists can be used when selecting moderators. For example, moderator section can be restricted to a set of individuals included on a white list. Alternatively, a set of individuals included in a black list can be excluded from a selection process regardless of their suitability as determined from other factors (i.e., a moderator suitability score for a person on a black list may be irrelevant). Further, applicable white/black lists to be used, if any, when selecting moderators can vary based upon meeting specific conditions and variables.

An attendance predictor 124 module can be used to determine a likelihood that a moderator will be unable to attend or moderate a meeting. In one embodiment, an absence prediction can be based upon explicit moderator, meeting owner, meeting participant input to the management software 121 that a moderator is unable to function as a meeting moderator. In another embodiment, the predictor 124 can base its determination by analyzing a set of electronic documents. These documents can include communications involving a moderator. The communications can involve one or more communication servers 150 (e.g., email servers, IM servers, voice servers, etc.), which can each maintain electronic records of communications in an analyzable data store. Other data sources 160 besides those of communication servers 150 can also exist, which are analyzed by predictor 124 to determine whether a moderator will be attending a designated meeting.

In one embodiment, criteria used by predictor 124 can be configured by authorized users. For example, section 240 of interface 210 shows some sample prediction parameters. The parameters can define what data sources are analyzed by predictor 124. Sources can include, calendar entries, email messages, voice mail messages, IM messages, travel system data, a physical location of a moderator at a time proximate to a meeting, and the like. For example, predictor 124 can search electronic message for key words indicative of whether a moderator will attend/not attend a meeting. Use of travel system data can determine whether a moderator plans on being in a geographic region of a meeting at an established meeting time. In one embodiment, GPS data from a moderator's cell phone, in-vehicle navigation system, and the like can determine a current location of a moderator. When this location is different from a meeting location and when physical presence is needed to moderate a meeting (as opposed to a moderator using a tele-presence option to virtually attend a meeting), then predictor 124 can determine it unlikely that a moderator will attend a meeting in a timely fashion, which can trigger an appointment of a replacement.

Data sources are not limited to those of section 240, nor are the selection criteria limited to those of section 220. Another source of moderator selection and/or absentee prediction can include a social networking system. For example, affiliations between different key participants in a meeting and a candidate moderator, as determined from a social networking system, can be important criteria when selecting a replacement moderator. In another example, communications and/or events detailed within a social networking system, which can conflict with a scheduled meeting, can be used when predicting moderator absence.

A security handler 126 module of meeting management software 121 can adjust security settings of documents, calendar entries, meeting resources, and the like whenever a moderator of a meeting is changed. For example, a meeting moderator may have permissions to schedule a meeting room, communicate with meeting participants, and the like, which are denied to others who are not appointed as meeting moderator. In one embodiment, a repository of meeting specific documents may exist to which a meeting moderator is granted access by handler 126 by virtual of a role of moderator. In one embodiment, meeting specific content can be electronically conveyed to a moderator as appropriate by handler 126. In another embodiment, passwords and/or authorization codes can be adjusted for a new moderator and/or the moderator can be conveyed suitable codes, when appointed. For instance, a user appointed moderator by assigner 122 can be conveyed suitable authorization codes, digital certificates, documents, document links, and the like for a meeting by handler 126. Security handler 126 can also revoke elevated permissions related to a moderator role from a replacement should a failback event occur, where an original moderator is restored as moderator for a meeting.

A notifier 126 module can communicate meeting updates to suitable meeting participants and other relevant people. In one embodiment, notifier 128 can establish messages within a meeting management software application itself, which can be viewed be users accessing meeting data. In another embodiment, one or more communication servers 150 can be utilized to convey messages regarding meeting updates and to acquire feedback, if required. For example, when a moderator changes, a set of users who initially refused to attend a meeting can optionally be re-prompted in a situation where a moderator choice for a meeting is believed to affect participant attendance. Notifier 128 can also send messages to candidate moderators soliciting feedback as to whether a selected person is willing to be a substitute moderator for a meeting. Notifier 128 can query a current moderator and confirm whether this person will or will not be able to moderate a meeting.

As used herein, server 110 can include a set of one or more physical devices configured to manage meetings. The server 110 can be integrated into a calendaring server, a project management server, a communication server, etc. or can be a stand-alone server providing moderator failover and failback capabilities. Server 110 can be a virtual server or a physical one. In various embodiments, server 110 can be implemented in a stand-alone manner or as a cluster of interconnected devices.

Meeting management software 121 can be a software (or firmware) implemented computer program product. The software 121 can be an integrated part of a larger program, can be a plug-in module that extends a larger program, or can be a service (e.g., Web service, SOA service, etc.) that provides functionality expressed herein. The larger program can be a calendaring program, a project management program, a resource reservation program, a communication program, and the like.

Communication server 150 can include an email server, an instant messaging server, a VoIP server, a fax server, a bulletin board, a social networking server, a blog server, an RSS server, and the like. The client 140 can include, but is not limited to, a personal computer, a mobile phone, an embedded computing device, a kiosk, a voice telephone, a Web tablet, a messaging appliance, and the like.

Network 165 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 165 can include local components and data pathways necessary for communications to be exchanged among computing device components and between integrated device components and peripheral devices. The network 165 can also include network equipment, such as routers, data lines, hubs, and intermediary servers which together form a packet-based network, such as the Internet or an intranet. The network 165 can further include circuit-based communication components and mobile communication components, such as telephony switches, modems, cellular communication towers, and the like. The network 165 can include line based and/or wireless communication pathways.

Data stores 118, 160 (and non-volatile memory 113 can be physically implemented within any type of hardware including, but not limited to, a magnetic disk, an optical disk, a semiconductor memory, a digitally encoded plastic memory, a holographic memory, or any other recording medium. Each data store 118, 160 can be a stand-alone storage unit as well as a storage unit formed from a plurality of physical devices, which may be remotely located from one another. Additionally, information can be stored within each data store 118, 160 in a variety of manners. For example, information can be stored within a database structure or can be stored within one or more files of a file storage system, where each file may or may not be indexed for information searching purposes.

It should be noted that specifics of the user interfaces 144, 210 are presented for illustrative purposes only and are not intended to constrain the invention. That is, user interfaces of system 100 can include graphical user interface (GUI), voice user interfaces (VUI), text user interfaces (TUI), multi-modal user interfaces, etc. having any of a variety of layouts, interface controls, and the like.

Additionally, although a client-server configuration is shown for system 100, the disclosure is not so limited. For example, meeting management software 121 can be implemented in a peer-to-peer configuration, where functionality of software/firmware 120 executes in one or more client 140. In another example, a stand-alone software application can include both client and server functions expressed in system 100.

Although the disclosure has been described for a meeting role of moderator, the failover and failback capability expressed herein can be applied to any definable meeting role. For example, a resource manager role can exist for a person in charge of acquiring overhead projectors, coffee, food, and the like. In one embodiment, system 100 can implement a failover and failback capability for the resource manager role. In another example, a company representative (meeting participant) can be a meeting role that utilizes the failover and failback capability.

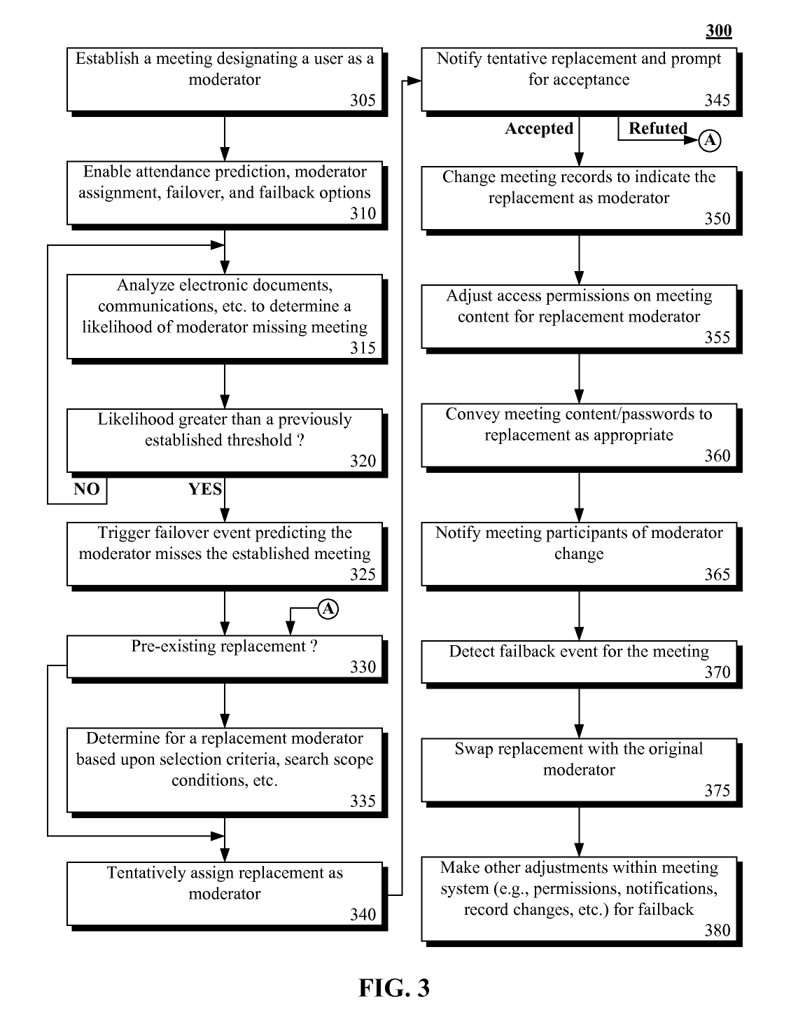

FIG. 3 is a flow chart of a method 300 implementing failover and failback functionality for meeting moderators in accordance with an embodiment of the inventive arrangements disclosed herein. The method 300 can be implemented in context of system 100.

Method 300 can begin in system 305, where a meeting designating a user as a moderator can be established. In step 310, attendance prediction, moderator assignment, failover, and failback options can be enabled within meeting management software. Each of these options can be activated or deactivated by an authorized software administrator or user.

In step 315, electronic documents, communications, etc. can be analyzed to determine a likelihood that a moderator will miss a meeting. In step 320, the determined likelihood can be compared against a previously established threshold. When the likelihood is less than the threshold, analysis can continue after a delay as shown by the loop from step 320 to step 315. When the likelihood is greater than the threshold, it can be predicted that the moderator will miss the meeting, which triggers a failover event for the moderator.

In step 330, a check for a pre-existing or previously established replacement can be made. If no replacement exists, then a replacement moderator can be determined in step 335. The determination can be based upon selection criteria, search scope conditions, and other factors. Determinations can be deterministic or heuristic depending upon implementation.

A tentative replacement can be assigned as moderator in step 340. In step 345, the tentative replacement can be notified and prompted for acceptance of the moderator role. For example, a message can be sent via email or via a calendaring application, which the message recipient can respond to. If the tentative replacement refuses the assignment, the method can loop from step 345 to step 330, where another user can be selected as replacement moderator.

If the message recipient accepts the assignment of moderator, meeting records can be changed to indicate the new moderator's identity, as shown by step 350. In step 355, access permissions on meeting content can be changed for the replacement moderator. In step 360 meeting content (e.g., electronic documents, contact lists, agendas, presentations, etc.) can be conveyed to the replacement. In step 365, meeting participants can be notified of the moderator change.

This moderator change will persist for the meeting unless a failback event is detected, as shown by step 370. The failback event causes the original moderator and the replacement to be swapped, as shown by step 375. In step 380, adjustments to the meeting system can be made responsive to the moderator swap. For example, security permissions can be adjusted, notifications can be sent, meeting database records can be changed and the like.

In one embodiment, a failback can be intentionally prevented using a configurable setting. When failback is disabled, an appearance of an original moderator will not change current meeting assignments. Disablement of a failback can be tied to a determinable condition, such as acceptance of a replacement moderator by all meeting attendees. Further, time thresholds can be included which determine at least in part whether a failback is enabled or not for a meeting. For example, a setting can disable a failback when a current time is within forty eight hours of a scheduled meeting, which assumes it would be inconvenient for all involved to have a moderator change close to a designated meeting start time.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A meeting management software system comprising:
meeting management software stored in a storage medium comprising a moderator assigner, said moderator assigner comprising a moderator failover capability and a moderator failback capability, wherein said moderator failover capability is configured to substitute a replacement for a moderator when the moderator is determined to be unavailable for a scheduled meeting, wherein said moderator failback capability is configured to substitute a moderator for a replacement when a believed to be unavailable moderator is determined to be available for a scheduled meeting for which the replacement has been previously substituted.

2. The system of claim 1, said moderator assigner is configured to utilize a plurality of user configured factors and programmatically defined rules to determine a replacement for the scheduled moderator from a plurality of candidates.

3. The system of claim 1, said moderator assigner is configured to filter the plurality of candidates before determining a replacement based upon user configured scope limiting parameters.

4. The system of claim 1, said meeting management software further comprising:
an attendance predictor configured to predict whether a scheduled moderator will be attending a scheduled meeting before the scheduled meeting occurs based upon an analysis of communications and electronic content related to the scheduled moderator.

5. The system of claim 1, said meeting management software further comprising:
a security handler configured to adjust access privileges related to a scheduled meeting handled by the meeting management software, wherein adjustments to the access privileges are based upon a moderator role and meeting content to be accessed by a user with the moderator role, wherein the adjustments increase permissions for a replacement when the moderator failover capability is enacted, and wherein the adjustments decrease permissions for the replacement when the failback capability is enacted.

6. The system of claim 1, said meeting management software further comprising:
a notifier configured to convey messages to meeting suitable participants when the moderator failback capability is enacted and when the moderator failback capability is enacted.

7. The system of claim 1, said moderator assigner being configured to selectively disable the moderator failback capability, wherein when the moderator failback capability is disabled and when the believed to be unavailable moderator is determined to be available for the scheduled meeting, the replacement retains a role of moderator for the scheduled meeting.

8. A method for meeting management comprising:
detecting a failover event that predicts a scheduled moderator for a meeting is likely to be unable to attend the meeting;
responsive to detecting the failover event, assigning a replacement for the scheduled moderator; and
updating records of a meeting management system to reflect the assigned replacement.

9. The method of claim 8, further comprising:
analyzing a plurality of electronic documents and communications to determine that a high likelihood exists that the scheduled moderator is likely to miss the meeting,
responsive to results from analyzing the plurality of electronic documents and communications, firing the failover event.

10. The method of claim 8, further comprising:
utilizing a plurality of user configured factors and programmatically defined rules to determine a tentative replacement for the scheduled moderator from a plurality of candidates.

11. The method of claim 10, further comprising:
filtering the plurality of candidates before determining a tentative replacement based upon user configured scope limiting parameters.

12. The method of claim 10, wherein the user configured factors comprise at least one of: seniority, skill level, expertise, and location.

13. The method of claim 10, further comprising:
computing a suitability score for each of the candidates in the set; and
determining the tentative replacement based upon the computed suitability score.

14. The method of claim 10, further comprising:
prompting the tentative replacement to accept or refute an assignment as the replacement;
receiving a response from the prompting;
when the response indicates an acceptance, assigning the tentative replacement as the replacement for the scheduled moderator; and
when the response indicates a refutation, determining a next most suitable candidate as the tentative replacement and repeating the prompting for the next most suitable candidate to accept or refute the assignment and receiving the response from the prompting for the next most suitable candidate.

15. The method of claim 8, further comprising:
detecting a failback event that indicates the scheduled moderator will likely be able to attend the meeting even though the replacement has been assigned;
responsive to detecting the failback event, reassigning the scheduled moderator as moderator for the meeting in place of the replacement; and
updating records of the meeting management system to reflect the reassigning of the scheduled moderator for the meeting.

16. The method of claim 8, further comprising:
detecting a failback event that indicates the scheduled moderator will likely be able to attend the meeting even though the replacement has been assigned;
determining that a failback prevention condition has been established for the meeting; and
responsive to the failback prevention condition, retaining the replacement in a role of moderator for the meeting.

17. A computer program product for meeting management comprising a computer usable medium having computer usable program code embodied therewith, the computer program product comprising:
computer usable program code configured to detect a failover event that predicts a scheduled moderator for a meeting is likely to be unable to attend the meeting;
computer usable program code configured to, responsive to detecting the failover event, assign a replacement for the scheduled moderator; and
computer usable program code configured to update records of a meeting management system to reflect the assigned replacement.

18. The computer program product of claim 17, further comprising:
computer usable program code configured to analyze a plurality of electronic documents and communications to determine that a high likelihood exists that the scheduled moderator is likely to miss the meeting; and
computer usable program code configured to, responsive to results of analyzing the plurality of electronic documents and communications, fire the failover event.

19. The computer program product of claim 17, further comprising:
computer usable program code configured to utilize a plurality of user configured factors and programmatically defined rules to determine a tentative replacement for the scheduled moderator from a plurality of candidates.

20. The computer program product of claim 19, further comprising:
computer usable program code configured to filter the plurality of candidates before determining a tentative replacement based upon user configured scope limiting parameters.
